(19) United States
(12) Patent Application Publication
(10) Pub. No.: US 2014/0160998 A1
(43) Pub. Date: Jun. 12, 2014

(54) SHIP STATION COMMUNICATION APPARATUS AND SHIP STATION COMMUNICATION METHOD

(71) Applicant: Electronics and Telecommunications Research Institute, Daejeon (KR)

(72) Inventors: Ok Sun PARK, Daejeon (KR); Hyoung Oh BAE, Daejeon (KR); Jae Kyung LEE, Daejeon (KR); Dae Ho KIM, Daejeon (KR)

(73) Assignee: Electronics and Telecommunications Research Institute, Daejeon (KR)

(21) Appl. No.: 14/012,376

(22) Filed: Aug. 28, 2013

(30) Foreign Application Priority Data
Dec. 10, 2012 (KR) 10-2012-0142540

(51) Int. Cl. H04B 1/56

(52) U.S. Cl. CPC H04B 1/56
USPC 370/277

(57) ABSTRACT

Disclosed are a ship station communication apparatus and a ship station communication method that enable direct communication between adjacent ships as well as two-way communication between a ship station and a coast station without increasing a size of a ship station or costs. A ship station communication apparatus for communication between a ship station and another ship station and communication between the ship station and a coast station according to an exemplary embodiment of the present invention may include a first switch configured to switch an operation between a transmission unit of the ship station and a reception unit of the ship station; and a second switch configured to switch a frequency of the reception unit.

### CROSS-REFERENCE TO RELATED APPLICATIONS

This application claims priority to and the benefit of Korean Patent Application No. 10-2012-0142540 filed in the Korean Intellectual Property Office on Dec. 10, 2012, the entire contents of which are incorporated herein by reference.

### TECHNICAL FIELD

The present invention relates to a ship station communication apparatus and a ship station communication method. More particularly, the present invention relates to a ship station communication apparatus and a ship station communication method that enable direct communication between adjacent ship stations as well as two-way data communication between a ship station and a coast station.

### BACKGROUND ART

Existing maritime communication is generally based on communication between a ship station and a coast station for safe voyage and ship control.

The ship station is operated while moving to a mobile radio station installed in a ship or stopping at a point aside from a predetermined point. The coast station is an immovable radio station opened on the shore, which communicates with the ship station or an automatic distress notification station. A regulation regarding an operation of a radio control act, such as allowing a coast station to demand that an action required to remove interference should be taken against an interfering ship station when an operation of a ship station is being interfered by the other ship station, may exist.

In the existing maritime communication, communication is performed from a ship to a coast station or from the coast station to the ship. Communication between ship stations of ships manually selects a simplex channel and supports only analog voice communication and thus, is vulnerable to security and automation is impossible.

In the related art, a ship station operates using a half-duplex communication method for communication with a coast station and thus, includes a single transmitter to transmit a signal from the ship station and a single receiver to receive a signal from the coast station. As described above, a channel needs to be manually switched for analog voice communication between ship stations.

Currently, a demand for a communication service, such as an e-mail or a messenger at sea, is gradually increasing. In particular, an amount of data communication traffic in a message form rather than voice communication is expected to increase even between ships. However, there are issues in that cell coverage is limited at sea and sufficient capacity is not provided. Such issues should not interrupt traffic for safe voyage between an in-cell ship and the coast station. Accordingly, to support direct communication between a ship station of a ship and a ship station of another ship may be very efficient in terms of safety and general data communication at sea.

Meanwhile, a next generation maritime communication system is being evolved from an analog scheme to a digital scheme. Accordingly, a ship station of the next generation maritime communication system needs to automatically switch a communication mode with a coast station and a direct communication mode between ship stations.

### SUMMARY OF THE INVENTION

The present invention has been made in an effort to provide a ship station communication apparatus and a ship station communication method that enable direct communication between adjacent ships as well as two-way communication between a ship station and a coast station without increasing a size of a ship station or costs according to the related art.

An exemplary embodiment of the present invention provides a ship station communication apparatus for communication between a ship station and another ship station and communication between the ship station and a coast station, the apparatus including: a first switch configured to switch an operation between a transmission unit of the ship station and a reception unit of the ship station; and a second switch configured to switch a frequency of the reception unit.

The second switch may switch the frequency of the reception unit to any one of a frequency (F_{SS}) used to receive data from the other ship station and a frequency (F_{CS}) used to receive data from the coast station.

When the ship station is to transmit data to any one of the other ship station and the coast station, the first switch may be switched to be connected to a first radio frequency (RF) frontend unit connected to the transmission unit.

When the ship station is to receive data from the coast station, the first switch may be switched to be connected to the second switch, and the second switch may be switched to be connected to a third RF frontend unit connected to the reception unit.

When the ship station is to receive data from the other ship station, or when a carrier is detected, the first switch may be switched to be connected to the second switch, and the second switch may be switched to be connected to a second RF frontend unit connected to the reception unit.

The communication between the ship station and the coast station may use a half duplex communication scheme and the communication between the ship station and the other ship station may use a simplex communication scheme.

The ship station communication apparatus may further include a control unit configured to obtain information about the coast station, register information about the ship station to a database of the coast station, and perform a radio access procedure including a channel allocation process for the communication when the ship station is powered on or enters into a communication area of the coast station.

The control unit may transmit and receive information about an access slot and a transmission slot to and from the other ship station in order to transmit and receive data between the ship station and the other ship station.

Another exemplary embodiment of the present invention provides a ship station communication method for communication between a ship station and another ship station and communication between the ship station and a coast station, the method including: a first switch operation of controlling a first switch for switching an operation between a transmission unit of the ship station and a reception unit of the ship station; and a second switch operation of controlling a second switch for switching a reception frequency.

The second switch operation may switch the reception frequency to any one of a frequency (F_{SS}) used to receive data from the other ship station and a frequency (F_{CS}) used to receive data from the coast station.

When the ship station is to transmit data to any one of the other ship station and the coast station, the first switch operation may control the first switch to be connected to a first RF frontend unit connected to the transmission unit.

When the ship station is to receive data from the coast station, the first switch operation may control the first switch to be connected to the second switch, and the second switch operation may control the second switch to be connected to a third RF frontend unit connected to the reception unit.

When the ship station is to receive data from the other ship station, or when a carrier is detected, the first switch operation may control the first switch to be connected to the second switch, and the second switch operation may control the second switch to be connected to a second RF frontend unit connected to the reception unit.

The communication between the ship station and the coast station may use a half duplex communication scheme and the communication between the ship station and the other ship station may use a simplex communication scheme.

The ship station communication method may further include a control operation of obtaining information about the coast station, registering information about the ship station to a database of the coast station, and performing a radio access procedure including a channel allocation process for the communication when the ship station is powered on or enters into a communication area of the coast station.

The control operation may transmit and receive information about an access slot and a transmission slot to and from the other ship station in order to transmit and receive data between the ship station and the other ship station.

According to exemplary embodiments of the present invention, direct communication between ships as well as communication between a ship station and a coast station is enabled.

According to exemplary embodiments of the present invention, it is possible to improve communication quality and to increase system capacity by automatically performing a radio access procedure without increasing complexity of a ship station.

According to exemplary embodiments of the present invention, it is possible not to affect communication between a ship station and a coast station for safe voyage by providing direct communication between ship stations even though an amount of in-cell traffic increases.

According to exemplary embodiments of the present invention, it is possible to provide communication between adjacent ship stations even outside a communication area of a coast station, without control of the coast station.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a ship station communication apparatus according to an exemplary embodiment of the present invention.

FIG. 2 is a diagram to describe a connection between a first switch and a second switch of a ship station communication apparatus according to an exemplary embodiment of the present invention for transmission from a ship station to a coast station or another ship station.

FIG. 3 is a diagram to describe a connection between a first switch and a second switch of a ship station communication apparatus according to an exemplary embodiment of the present invention for reception of a ship station from a coast station.

FIG. 4 is a diagram to describe a connection between a first switch and a second switch of a ship station communication apparatus according to an exemplary embodiment of the present invention for carrier detection of a ship station or reception of the ship station from another ship station.

FIG. 5 is a flowchart to describe a radio access procedure performed by a control unit of a ship station communication apparatus according to an exemplary embodiment of the present invention for direct communication between a ship station and another ship station.

FIG. 6 is a flowchart illustrating a ship station communication method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description and accompanying drawings, like reference numerals refer to like constituent elements and thus, a repeated description will be omitted. When it is determined that the detailed description related to a related known function or configuration may make the purpose of the present invention unnecessarily ambiguous in describing the present invention, the detailed description will be omitted here.

When it is described that a predetermined constituent element is “connected to” or “accessed to” another constituent element, the predetermined constituent element may be directly connected to or accessed to the other constituent element, however, should be understood that still another constituent element may be present between the predetermined constituent element and the other constituent element. On the other hand, when it is described that the predetermined constituent element is “directly connected to” or “directly accessed to” the other constituent element, it should be understood that still another constituent element is absent between the predetermined constituent element and the other constituent element.

In the present specification, unless particularly described in the sentence, a singular form may also include a plural form. “Includes (comprises)” and/or “including (comprising)” used in the present specification does not exclude the presence or addition of at least one another constituent element, step, operation, and/or device with respect to the described constituent element, step, operation, and/or device.

The present invention relates to a communication apparatus of a ship station present for communication in a ship. More particularly, the present invention is an invention for communication between a ship station and a coast station and communication between the ship station and a ship station of another ship.

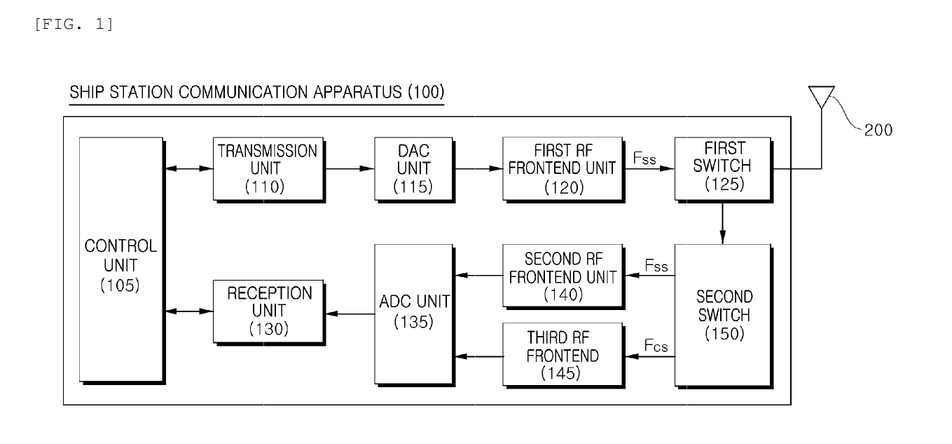

FIG. 1 is a block diagram illustrating a ship station communication apparatus 100 according to an exemplary embodiment of the present invention.

Referring to FIG. 1, the ship station communication apparatus 100 according to an exemplary embodiment of the present invention includes a control unit 105, a transmission unit 110, a digital-to-analog conversion (DAC) unit 115, a first radio frequency (RF) frontend unit 120, a first switch 125, a reception unit 130, an analog-to-digital conversion (ADC) unit 135, a second RF frontend unit 140, a third RF frontend unit 145, and a second switch 150.

The control unit 105 performs a radio access procedure. The control unit 105 enables a receiver to be efficiently reused by controlling the number of data symbols, the number of control symbols, and a resource position. A function performed by the control unit 105 of the ship station communication apparatus 100 according to an exemplary embodiment of the present invention may be similar to a function of a control unit of an existing ship station, but the control unit 105 may perform a radio access procedure different from the existing ship station in order to perform direct communication with another ship station. The radio access procedure performed by the control unit 105 will be described in detail after describing a connection relationship between the first switch 125 and the second switch 150 according to transmission and reception of the ship station.

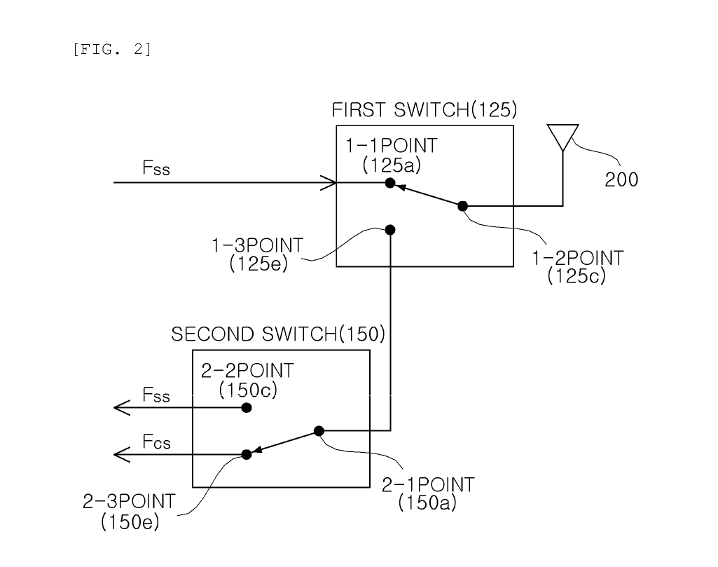

FIG. 2 is a diagram to describe a connection between the first switch 125 and the second switch 150 of the ship station communication apparatus 100 according to an exemplary embodiment of the present invention for transmission from a ship station to a coast station or another ship station.

F_{SS} is a frequency used when the ship station transmits data to the other ship station or the coast station. F_{SS} is a frequency used when the ship station transmits and receives data to and from the other ship station.

F_{CS} is a frequency used when the coast station transmits data to the ship station.

A configuration of the first switch 125 and the second switch 150 of the ship station communication apparatus 100 according to an exemplary embodiment of the present invention will be initially described with reference to FIG. 2.

In FIG. 2, when the ship station communication apparatus 100 according to the present invention is to transmit data to the other ship station or the coast station, the first switch 125 connects a 1-2 point 125c connected to an antenna 200 of the first switch and a 1-1 point 125a.

When the 1-2 point 125c and the 1-1 point 125a of the first switch 125 are connected, coded and modulated digital data transmitted from the transmission unit 110 may be converted to analog data by the DAC unit 115 and data may be transmitted to the coast station or the other ship station through the first RF frontend unit 120 and the antenna 200. The first RF frontend unit 120 performs an RF frontend function.

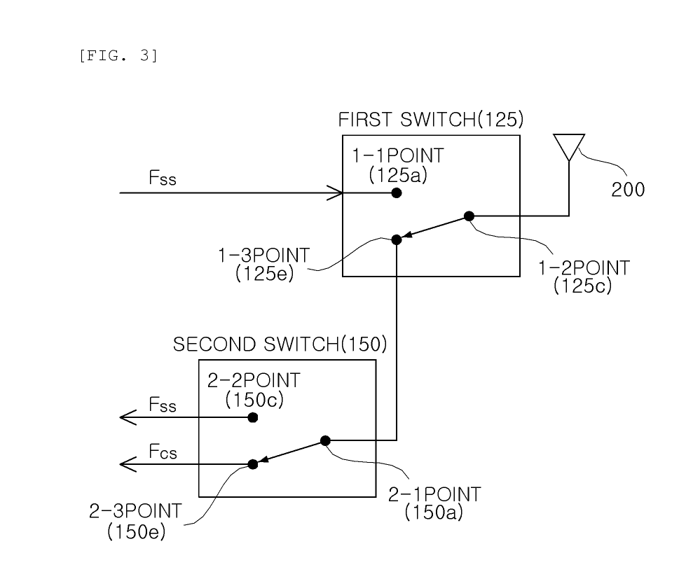

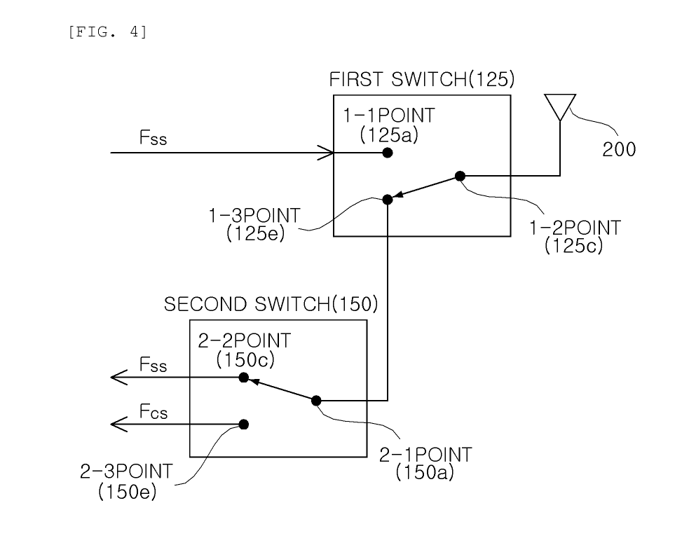

When the ship station communication apparatus 100 according to the present invention is communicating with the other ship station, the second switch 150 may connect a 2-1 point 150a and a 2-2 point 150c in preparation for reception. When the ship station communication apparatus 100 is communicating with the coast station, the second switch 150 may connect the 2-1 point 150a and a 2-3 point 150e in preparation for reception. A detailed description relating to a connection of the second switch 150 will be described in detail with reference to FIGS. 3 and 4.

FIG. 3 is a diagram to describe a connection between the first switch 125 and the second switch 150 of the ship station communication apparatus 100 according to an exemplary embodiment of the present invention for reception of a ship station from a coast station.

Describing the connection between the first switch 125 and the second switch 150 for the ship station to receive data transmitted from the coast station with reference to FIG. 3, the first switch 125 connects the 1-2 point 125c connected to the antenna 200 of the first switch 125 and a 1-3 point 125e. The second switch 150 connects the 2-1 point 150a connected to the 1-3 point 125e of the first switch 125, and the 2-3 point 150e. When the 2-1 point 150a and the 2-3 point 150e of the second switch 150 are connected, data may be transmitted from the ship station to the coast station. That is, when the ship station communication apparatus 100 according to the present invention receives data from the coast station through the antenna 200 of the ship station communication apparatus 100, the third RF frontend unit 145 performs an RF frontend function. The ADC unit 135 may convert analog data to digital data. The reception unit 130 may demodulate and decode the received digital data.

Data to be transmitted from a communication apparatus of a ship station to a coast station may include a position of the ship station and may also include information about a position, velocity, path, and time of a ship at which the ship station is positioned, using a global positioning system (GPS) generally mounted to a ship station communication apparatus. An interval at which the communication apparatus of the ship station transmits data including a position and the like of the ship station to the coast station may be set to be within one second to 60 seconds for safety of the ship.

FIG. 4 is a diagram to describe a connection between the first switch 125 and the second switch 150 of the ship station communication apparatus 100 according to an exemplary embodiment of the present invention for carrier detection of a ship station or reception of the ship station from another ship station.

Describing the connection between the first switch 125 and the second switch 150 for the ship station to receive data from a ship station (another ship station) of another ship with reference to FIG. 4, the first switch 125 connects the 1-2 point 125c connected to the antenna 200 of the first switch 125 and the 1-3 point 125e. The second switch 150 connects the 2-1 point 150a connected to the 1-3 point 125e of the first switch 125 and the 2-2 point 150c. When the 2-1 point 150a and the 2-2 point 150c of the second switch 150 are connected, data may be transmitted from the ship station to the other ship station.

Specifically, when the ship station communication apparatus 100 according to the present invention receives data from the other ship station through the antenna 200 of the ship station communication apparatus 100, the second RF frontend unit 140 performs an RF frontend function. The ADC unit 135 may convert analog data to digital data. The reception unit 130 may demodulate and decode the received digital data.

When the ship station performs direct communication with the other ship station using the ship station communication apparatus 100, a radio access procedure may be initially performed.

The radio access procedure will be described in detail.

When the ship station communication apparatus 100 is powered on or enters into a communication area of the coast station or an adjacent ship station, the control unit 105 automatically performs the radio access procedure without a separate radio access procedure command. The radio access procedure performed by the control unit 105 includes a radio access procedure for communication between the ship station and the coast station and a radio access procedure for direct communication between the ship station and the other ship station.

The radio access procedure between the ship station and the coast station may obtain information about the coast station, register ship station information to a database of the coast station, and perform a channel allocation process for data communication.

The coast station monitors positions and traffic states of ship stations that are in a radio access state. The coast station may change a position of an access slot or a transmission slot with the ship station communication apparatus 100 based on a traffic amount of a channel. Alternatively, when reception signal levels of ship stations in communication using a half-duplex communication scheme within a communication area decrease to less than or equal to a reference value, or when communication error rates thereof increase to greater than or equal to a reference value, the coast station may switch a communication scheme to a simplex mode.

Alternatively, when the ship station demands communication, the coast station may switch a communication scheme to a simplex communication scheme. Alternatively, when an in-cell ship station is out of the communication area, the coast station performs the radio access procedure by terminating the simplex communication scheme and switching a communication scheme to a half-duplex communication scheme.

When the ship station is powered off or moves out of the communication area of the coast station, the control unit 105 may automatically terminate a radio access.

The control unit 105 may perform the radio access procedure for the direct communication between the ship station and the other ship station.

The ship station and the other ship station that perform the direct communication may be classified into a master ship station and a slave ship station.

The master ship station needs to transmit, to the slave ship station, information for notifying an access slot. When access slot information is received, the slave ship station is synchronized with the corresponding access slot and performs a registration procedure. In the case of communication based on a time division multiple access (TDMA) scheme, a slot corresponds to a channel.

The ship station communication apparatus 100 according to an exemplary embodiment of the present invention may be a communication apparatus of the master ship station and may also be a communication apparatus of the slave ship station.

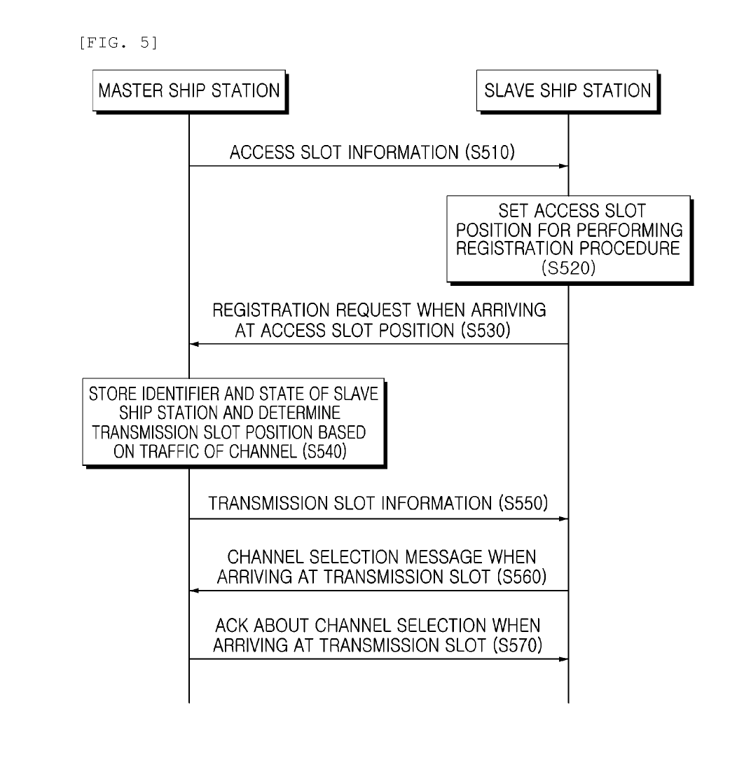

The radio access procedure between the master ship station and the slave ship station will be described with reference to FIG. 5.

FIG. 5 is a flowchart to describe a radio access procedure performed by the control unit 105 of the ship station communication apparatus 100 according to an exemplary embodiment of the present invention for direct communication between a ship station and another ship station.

Referring to FIG. 5, the control unit 105 of the ship station communication apparatus 100 of the main ship station transmits access slot information (operation S510).

When access slot information transmitted from the master ship station is received, the control unit 105 of the ship station communication apparatus 100 of the slave ship station sets an access slot position for performing a registration procedure (operation S520).

When the slave ship station arrives at the access slot position, the control unit 105 of the ship station communication apparatus 100 of the slave ship station transmits a registration request to the master ship station (operation S530).

The control unit 105 of the ship station communication apparatus 100 of the master ship station stores an identifier and a state of the slave ship station and determines a transmission slot position based on traffic of a channel (operation S540).

When the channel is available, the control unit 105 of the ship station communication apparatus 100 of the master ship station loads, to a registration response message, acknowledgement (ACK) that is an affirmative response and transmission slot information and transmits the registration response message to the slave ship station (operation S550). When the channel is unavailable, the control unit 105 of the ship station communication apparatus 100 of the master ship station may transmit, to the slave ship station, negative ACK (NACK) that is a negative response. The slave ship station may verify that the channel is unavailable, may load ACK to a registration ACK message, transmit the registration ACK message, and then wait again for a registration response.

When a transmission slot is activated and the control unit 105 of the ship station communication apparatus 100 of the slave ship station arrives at the transmission slot in operation 5550, the control unit 105 of the ship station communication apparatus 100 of the slave ship station transmits a message indicating a channel selection (operation S560).

When the control unit 105 of the ship station communication apparatus 100 of the master ship station arrives at the transmission slot, the control unit 105 of the ship station communication apparatus 100 of the master ship station transmits ACK about the channel selection (operation S570). From operation 5570, the direct communication between the master ship station and the slave ship station is enabled at the transmission slot position.

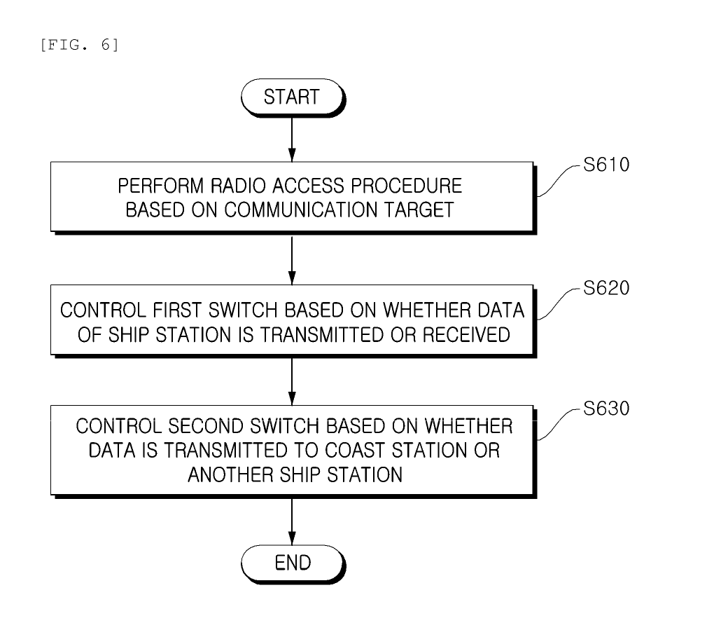

FIG. 6 is a flowchart illustrating a ship station communication method according to an exemplary embodiment of the present invention.

Describing the ship station communication method according to an exemplary embodiment of the present invention with reference to FIG. 6, the control unit 105 performs a suitable radio access procedure based on a communication target (operation S610). Specifically, the communication target is a coast station or another ship station. A radio access procedure of the control unit 105 regarding communication between the ship station and the coast station and a radio access procedure of the control unit 105 regarding communication between the ship station and the other ship station are described above.

A connection of the first switch 125 is controlled based on whether the ship station transmits or receives data to or from the coast station or the other ship station (operation S620).

A connection of the second switch 150 is controlled based on whether the ship station transmits data to the coast station or whether the ship station directly transmits data the other ship station (operation S630).

The ship station communication apparatus 100 and the ship station communication method according to exemplary embodiments of the present invention enable direct communication between ships as well as communication between a ship station and a coast station.

The ship station communication apparatus 100 and the ship station communication method according to exemplary embodiments of the present invention may improve communication quality and increase system capacity by automatically performing a radio access procedure without increasing complexity of a ship station.

The ship station communication apparatus 100 and the ship station communication method according to exemplary embodiments of the present invention may not affect communication between a ship station and a coast station for safe voyage by providing direct communication between ship stations although an amount of in-cell traffic increases.

The ship station communication apparatus 100 and the ship station communication method according to exemplary embodiments of the present invention may provide communication between adjacent ship stations without a control of a coast station even outside a cell area.

A block diagram of the ship station communication apparatus 100 according to exemplary embodiments of the present invention should be understood to indicate an exemplary objective perspective for embodying the principle of the present invention. Similarly, all of the flowcharts should be understood to indicate a variety of processes that can be expressed in computer-readable media and are implemented by a computer or a processor regardless of whether the computer or the processor is clearly illustrated.

Functions of various devices illustrated in the drawings that include the processor or a functional block indicated as a concept similar thereto may be provided by use of exclusive hardware and hardware having a capability of executing software in association with appropriate software. When such functions are provided by the processor, the functions may be provided by a single exclusive processor, a single shared processor, or a plurality of individual processors, and a portion thereof may be shared.

Clear use of the processor, control, or a terminology proposed as a concept similar thereto should not be interpreted by exclusively citing hardware having the capability of executing software, and should be understood to implicitly include ROM, RAM, and a nonvolatile memory for storing digital signal processor (DSP) hardware and software without limitation. Known and commonly-used other hardware may also be included.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A ship station communication apparatus for communication between a ship station and another ship station and communication between the ship station and a coast station, the apparatus comprising:
a first switch configured to switch an operation between a transmission unit of the ship station and a reception unit of the ship station; and
a second switch configured to switch a frequency of the reception unit.

2. The apparatus of claim 1, wherein the second switch switches the frequency of the reception unit to any one of a frequency (F_{SS}) used to receive data from the other ship station and a frequency (F_{CS}) used to receive data from the coast station.

3. The apparatus of claim 1, wherein when the ship station is to transmit data to any one of the other ship station and the coast station, the first switch is switched to be connected to a first radio frequency (RF) frontend unit connected to the transmission unit.

4. The apparatus of claim 2, wherein
when the ship station is to receive data from the coast station, the first switch is switched to be connected to the second switch, and
the second switch is switched to be connected to a third RF frontend unit connected to the reception unit.

5. The apparatus of claim 2, wherein
when the ship station is to receive data from the other ship station, or when a carrier is detected, the first switch is switched to be connected to the second switch, and
the second switch is switched to be connected to a second RF frontend unit connected to the reception unit.

6. The apparatus of claim 1, wherein the communication between the ship station and the coast station uses a half duplex communication scheme and the communication between the ship station and the other ship station uses a simplex communication scheme.

7. The apparatus of claim 1, further comprising:
a control unit configured to obtain information about the coast station, register information about the ship station to a database of the coast station, and perform a radio access procedure including a channel allocation process for the communication when the ship station is powered on or enters into a communication area of the coast station.

8. The apparatus of claim 7, wherein the control unit transmits and receives information about an access slot and a transmission slot to and from the other ship station in order to transmit and receive data between the ship station and the other ship station.

9. A ship station communication method for communication between a ship station and another ship station and communication between the ship station and a coast station, the method comprising:
a first switch operation of controlling a first switch for switching an operation between a transmission unit of the ship station and a reception unit of the ship station; and
a second switch operation of controlling a second switch for switching a reception frequency.

10. The method of claim 9, wherein the second switch operation switches the reception frequency to any one of a frequency (F_{SS}) used to receive data from the other ship station and a frequency (F_{CS}) used to receive data from the coast station.

11. The method of claim 9, wherein when the ship station is to transmit data to any one of the other ship station and the coast station, the first switch operation controls the first switch to be connected to a first RF frontend unit connected to the transmission unit.

12. The method of claim 10, wherein
when the ship station is to receive data from the coast station, the first switch operation controls the first switch to be connected to the second switch, and
the second switch operation controls the second switch to be connected to a third RF frontend unit connected to the reception unit.

13. The method of claim 10, wherein
when the ship station is to receive data from the other ship station, or when a carrier is detected, the first switch operation controls the first switch to be connected to the second switch, and
the second switch operation controls the second switch to be connected to a second RF frontend unit connected to the reception unit.

14. The method of claim 9, wherein the communication between the ship station and the coast station uses a half duplex communication scheme and the communication between the ship station and the other ship station uses a simplex communication scheme.

15. The method of claim 9, further comprising:
a control operation of obtaining information about the coast station, registering information about the ship station to a database of the coast station, and performing a radio access procedure including a channel allocation process for the communication when the ship station is powered on or enters into a communication area of the coast station.

16. The method of claim 15, wherein the control operation transmits and receives information about an access slot and a transmission slot to and from the other ship station in order to transmit and receive data between the ship station and the other ship station.
